(19) United States
(12) Patent Application Publication
(10) Pub. No.: US 2021/0051393 A1
(43) Pub. Date: Feb. 18, 2021

(54) Airbuns (EarBud and Scrunchy Combination)

(71) Applicant: Stephanie Ann Green, Milwaukie, OR (US)

(72) Inventor: Stephanie Ann Green, Milwaukie, OR (US)

(21) Appl. No.: 16/541,114

(22) Filed: Aug. 14, 2019

(51) Int. Cl. H04R 1/10; A45D 8/34

(52) U.S. Cl. CPC H04R 1/1091; H04R 1/1016; A45D 2008/002; A45D 8/34; H04R 2420/07; H04R 1/1041

(57) ABSTRACT

The purpose of this patent application is to obtain a patent on Airbuns, which is a combination between commercially available Earbuds and commercially available hair scrunchies The main purpose for this invention is to provide a convenient and discrete storage place for Earbuds when not in use. When the user needs the Earbuds, they unsnap it from the hair scrunchy and start using it to talk. When they are finished talking, they snap the Earbuds back onto the hair scrunchy and keep it there until they need to use it or charge it. If the user needs to charge it, he/she unsnaps the Earbuds from the hair scrunchy and places it on the charger and charge it how the user normally charges the Earbuds.

### CROSS-REFERENCE TO RELATED APPLICATIONS

This section is non-applicable to this patent application.

### STATEMENT REGARDING FEDERALLY SPONSORED RESEARCH OR DEVELOPMENT (IF APPLICABLE)

There are no rights to this invention under federally sponsored research and development programs.

### REFERENCE TO SEQUENCE LISTING, A TABLE, OR A COMPUTER PROGRAM LISTING COMPACT DISC APPENDIX

This section is non-applicable to this patent application.

### BACKGROUND OF THE INVENTION

This invention takes two existing commercially available products and combines them for a specific purpose or utility function. The main impetus for Airbuns is to provide a convenient place for Earbuds (or any wireless apparatus that is inserted into the ear for wireless hearing of cell phone audible sounds) to store for easy access. Also, the main reason is to not to look obvious when using Earbuds that are connected through a wireless headset, or in a hard to find storage box that users must quickly find in order to answer their phone. Many users never like to carry a case or wear a visible headset around their neck that contains obvious Earbuds. Out of need to have a discreet way to wear Earbuds, Stephanie invented airbuns, which makes the Earbuds look discreet while looking fashionable, Airbuns will come in all styles, designs and colors. The Earbud is connected to a hair scrunchy by either a magnet, snap, velcro or glue. The Earbuds will be attached in a discreet manner to the hair scrunchy. The Earbuds will be incorporated into the design of the hair scrunchy.

Stephanie Ann Green is a full-time working mother of 3 kids with an MBA, Her house is comprised of a family of five and her kids are always losing their wireless Earbuds. Stephanie noticed that existing accessories for Earbuds were lacking and wanted something more discrete and more fashionable. Hence the need for the invention of airbuns. The airbuns utility is a holding or storage facility, which is the hair scrunchy, for the Earbuds to be connected to in order to access them quickly and efficiently as well as discretely while being fashionable.

### BRIEF SUMMARY OF THE INVENTION

As mentioned above, there is a huge market and need for this product The invention is comprised of combining two separate commercially available products on the market currently into something that functions as its own utility (Earbuds and a hair scrunchy combined make airbuns along with adherence material).

### BRIEF DESCRIPTION OF THE SEVERAL VIEWS OF THE DRAWING

Please refer to separate diagram of Airbuns. Each element is properly labeled.

### DETAILED DESCRIPTION OF THE INVENTION

There is no other invention like this one the market. The process is simple with existing materials on the market. All materials are on the market currently so it's a matter of assembling existing materials that are commercially available. This invention requires the use of Earbuds and a hair scrunchy and an adherence material such as magnets, snaps, velcro or glue. The adherence material is installed on the Earbuds and the same adherence material is placed on the hair scrunchy and then the two are joined together in order to make a convenient and discreet storage space for the Earbuds. Essentially the two items are adhered together temporarily until the user needs the Earbuds, then he/she pulls the Earbuds off the hair scrunchy and places them into their ears and starts using them. When the user is finished, he/she adheres the Earbuds back onto the hair scrunchy. The Earhuds will be designed neatly into the hair scrunchy to try and conceal it as much as possible or make it blend in with the design.

### DRAWINGS

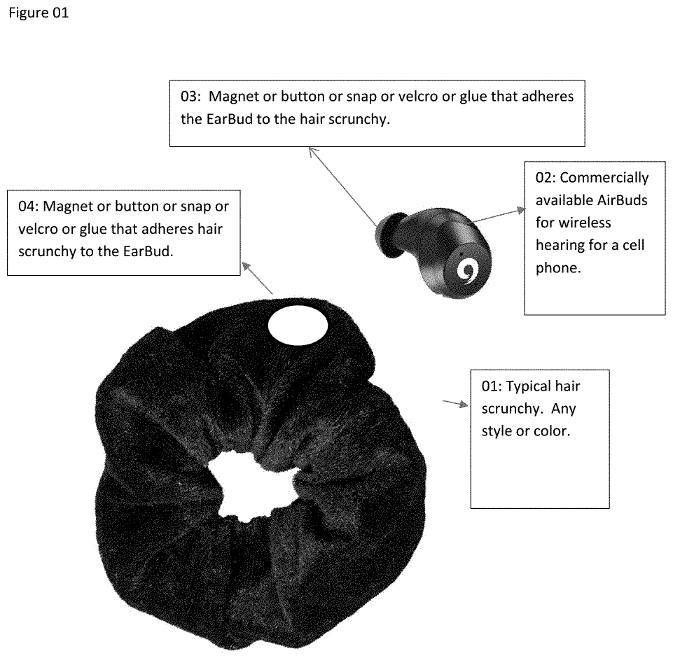

A sketch is attached as a separate drawing as FIG. 1.

Each item that is included in the drawing is labeled as follows:

01: Typical hair scrunchy. Any style or color.

02: commercially available Earbuds for wireless hearing for a cell phone.

03: Magnet or button or snap or velcro or glue that adheres the EarBud to the hair scrunchy.

04: Magnet or button or snap or velcro or glue that adheres hair scrunchy to the EarBud.

1. Airbuns are a combination of Earbuds (also known as a wireless apparatus that is inserted into the ear for wireless hearing of cell phone audible sounds) and a hair scrunchy that are temporarily adhered together in which makes a new idea and function. The user will wear the hair scrunchy in their hair like normal, but Earbuds when not in use, are adhered to it in a discreet manner.
(a) An Earbud (wireless apparatus that is inserted into the ear for wireless hearing of cell phone audible sounds) that is adhered to a hair scrunchy with adherence material such as magnets, glue, velcro and/or snaps,
(b) A hair scrunchy that has been designed to house Earbuds by means of an adherence material whereby the Earbuds are temporarily affixed to the hair scrunchy until the user needs to use the Earbuds.
(c) A hair scrunchy or hair tie that has Earbuds attached to it,
In this claim Earbuds and a hair scrunchy are already known and are not new. The hair scrunchy with Earbuds attached to it is the apparatus that is being claimed and patented,
For purposes of this patent, an Earbud is defined as a very small headphone, worn inside the ear in a wireless capacity.
For purposes of this patent, a hair scrunchy is a fabric-covered elastic used for holding back hair (as in a ponytail).
